(19) United States
(12) Patent Application Publication
(10) Pub. No.: US 2019/0240870 A1
(43) Pub. Date: Aug. 8, 2019

(54) DEVICE FOR DRYING GRANULES

(71) Applicant: MAAG AUTOMATIK GMBH, Grossostheim (DE)

(72) Inventors: Florian Fischer, Ebersberg (DE); Alexander Helm, Seligenstadt (DE)

(21) Appl. No.: 16/386,556

(22) Filed: Apr. 17, 2019

Related U.S. Application Data
(63) Continuation of application No. PCT/EP2017/001213, filed on Oct. 16, 2017.

(30) Foreign Application Priority Data
Oct. 17, 2016 (DE) 202016006420.8
Oct. 16, 2017 (WO) PCTEP2017001213

(51) Int. Cl. B29B 13/06; F26B 17/24; F26B 17/22; B29B 9/16

(52) U.S. Cl. CPC B29B 13/06; F26B 17/24; F26B 2200/08; B29B 9/16; F26B 17/22

(57) ABSTRACT

A device for drying granules, such as those made from a plastic material. The device can have a spiral arrangement of rotor blades on a rotor to propel process fluid through a sieve and separate the process fluid from granules by having sieve openings of a size smaller than the granules. The device can also have a fan wheel and a hollow shaft to create an air flow and improve separation and drying of granules. The device enables reliable automated drying of granules using less energy than prior art devices.

### CROSS REFERENCE TO RELATED APPLICATIONS

The present application is a Continuation Application of co-pending International Patent Application No. PCT/EP2017/001213 filed on Oct. 16, 2017, titled “DEVICE FOR DRYING GRANULES”, which claims priority to German Patent Application No. 20 2016 006 420.8 filed on Oct. 17, 2016. These references are incorporated herein in their entirety.

### FIELD

The present disclosure generally relates to a device for drying granules.

### BACKGROUND

The present disclosure relates to a device for drying granules, such as those made from a plastic material. Generally speaking, extruders or melt pumps press molten plastic raw material through nozzles of a perforated plate into a coolant, such as water. In this process, the material emerging through the openings of the nozzles is cut by a cutter arrangement in order to produce pellets. These pellets, or granules often are required to be dried prior to further processing.

Devices such as these are marketed and sold by the company MAAG AUTOMATIK GMBH® as centrifugal dryers under the product name CENTRO®. For the purpose of drying granules, additional pre- and/or post-dryers, such as pre-dewatering sections or drying beds may be required. This can entail added construction costs, use of additional space, increased maintenance costs, and higher energy consumption of the plant as a whole.

Prior art includes a granule dryer for abrasive and impact-sensitive plastic granules, in which moist air is evacuated through the sieve basket there and through holes contrived in the rotor. Other devices incorporate centrifugal dryers with conical sieve and rotor blade arrangements, however these do not overcome the disadvantages detailed above.

The present disclosure provides a device for drying granules which overcomes the disadvantages of the state of the art, and in particular to provides a device which, by simple constructive means, enables reliable automated drying of granules using as little energy as possible.

### BRIEF DESCRIPTION OF THE DRAWINGS

The detailed description will be better understood in conjunction with the accompanying drawings as follows:

FIG. 1 is an embodiment of a device for drying granules.

FIG. 2 is a cross-sectional view of the device for drying granules of FIG. 1.

FIG. 3 is a view of one embodiment of a rotor and fan wheel arrangement of the device for drying granules of FIG. 1 and FIG. 2.

FIG. 4 is a cross-sectional view of the rotor and fan wheel arrangement of FIG. 3.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a device for drying granules.

The device for drying granules can have a housing with a granule-process fluid inlet, a granule outlet and a fluid outlet, and a rotor with one or more rotor blades disposed thereon which impart a direction of movement to granules and to a process fluid, such as water. The process fluid can be separated from the granules in a dewatering area within the housing by at least one sieve having sieve openings of a size smaller than the granules. The sieve can encompass the outside of the rotor in at least one section.

In this manner, the process fluid can be passed from a sieve front side to a sieve back side in order to be separated from the granules.

The terms sieve front side and sieve back side designate the two sides of the sieve surface, namely the side on which the screened granules are retained and the back side of the sieve surface, where the process fluid and the materials, i.e. granules or dust, which are smaller than the sieve openings, end up after passing through the sieve openings.

The rotor can have a hollow shaft with a plurality of rotor holes which are at least partially disposed on the hollow shaft. A fan wheel can be used to draw air into the hollow shaft. In embodiments, the fan wheel can be attached coaxially to the rotor shaft such that by means of the fan wheel, air can be drawn into the inside of the hollow shaft via the granule outlet and the rotor holes and can be evacuated from the housing via a fan wheel air outlet. In embodiments, the rotor holes can be drilled holes, punch-outs, or any other openings made in the hollow shaft. The air which can be drawn in may be drawn in via the granule outlet or via other openings in the housing.

The device uses forces or force components imparted by the rotor to the granules and the process fluid to provoke forcible movement of the granules and process fluid in the direction of the dewatering sieve openings so that the granules of a certain size and the process fluid are separated from each other by passing through the corresponding sieve openings. In particular, the force component used to this end may be a centrifugal force component which moves the process fluid and granules centrifugally, or in a spiral movement based upon the shape and/or pitch of at least one rotor blade.

The fan wheel and the hollow shaft act in cooperation to create an air flow within the housing, preferably in a counterflow movement, such that dewatering, or separation of granules and process fluid can be performed in a particularly simple and reliable manner. The integration of a fan wheel coaxially attached to the hollow shaft provides a simple component for avoiding the need for additional bearings.

In embodiments, at least one rotor blade is disposed spirally on the hollow shaft. The at least one rotor blade can have an outer contour which matches the inner contour of the sieve, at least in sections. Therefore the at least one rotor blade is disposed with its respective outer edges at a prescribed distance from the inner contour of the sieve. In embodiments, the at least one rotor blade is spirally disposed on the hollow shaft to improve the transport of granules through the housing.

The configuration of the at least one rotor blade provides a simple constructive means of achieving effective transport of granules with an effective separation of granules and process fluid. In addition, operation of the device configured in this way also reduces or eliminates the tendency of granules to clump together in the region of the rotor.

In embodiments, the at least one rotor blade (when disposed spirally on the hollow shaft) can have a changing pitch from one end of the hollow shaft to another. In embodiments, the pitch can continuously change from one end of the hollow shaft to the other. Persons having ordinary skill in the art can determine desired pitch based upon desired dwell duration and imparted components of movement at the respective locations.

To further prevent the tendency of granules to clump in the region of the rotor, envelope curves on the outer contour of the at least one rotor blade and the inner contour of the sieve are arranged coaxially. In respective portions they are axially and uniformly distanced from each other. In embodiments, the inner envelope curve of the rotor blades has a radial distance from the outer envelope curve of the sieve in the region of four to twenty times the average diameter of the granules.

In embodiments, the at least one rotor blade and the sieve can have a conically tapering path, at least in sections, as seen from top to bottom in the vertical cross-section. Therefore, in the cross-section, the radial diameters of the at least one rotor blade and of the sieve increase from bottom to top. This facilitates particularly efficient dewatering while also reducing or eliminating the tendency of granules to clump after being separated from process fluid.

In embodiments, the rotor and the fan wheel are attached to each other such that they can be rotated at the same speed. The rotor and the fan wheel may be screwed together, welded to each other, or connected to each other in any way known to persons having ordinary skill in the art. This allows the rotor and the fan wheel to be driven by a common motor.

In embodiments, in order to exploit the gravity component during dewatering and to enable a counterflow of air in the device, the fan wheel can be disposed above the rotor.

The plurality of rotor holes can be disposed at least in a middle portion of the rotor. This allows for the counterflow of air, which facilitates particularly effective dewatering or separation of granules and process fluid. It further ensures that process fluid cannot enter the hollow shaft via rotor holes in the bottom portion of the rotor.

In embodiments, the rotor holes can have a diameter in the region of about 0.25 times to about 0.4 times the inner diameter of the hollow shaft. This ratio has been found to achieve a particularly strong flow of air through the device.

Additionally, in order to improve the transverse flow of air, rotor holes can have a diameter in the region of about 0.5 times to about 2 times the diameter of the granules near the ends of the hollow shaft. This allows for the creation of an additional flow of air in the top and bottom portions of the rotor in the assembled position. The size of the rotor holes also substantially prevents both process fluid and granules from entering the hollow shaft.

Therefore, in embodiments, the rotor holes in the middle portion of the hollow shaft of the rotor are substantially larger than in the end portions of the hollow shaft.

In embodiments, to permit particularly effective cleaning and improved servicing of the device, the rotor and the fan wheel can be removed upwards out of the housing.

The disclosure will be described in more detail below with reference to the embodiments cited in the following figures.

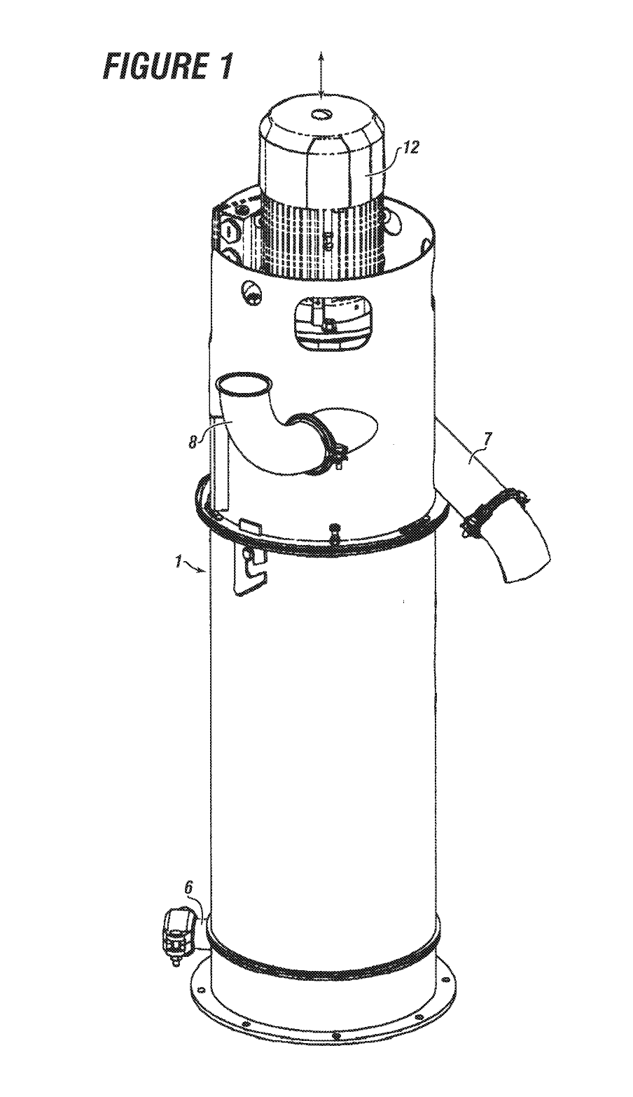

FIG. 1 is an embodiment of a device for drying granules. The device can have a housing 1 with a granule-process fluid inlet 6, a granule outlet 7 and a fluid outlet (not shown in the Figures). The internals of the device in this embodiment can, as will be described below, be removed upwards from the housing 1 of the device by lifting the top part of the device.

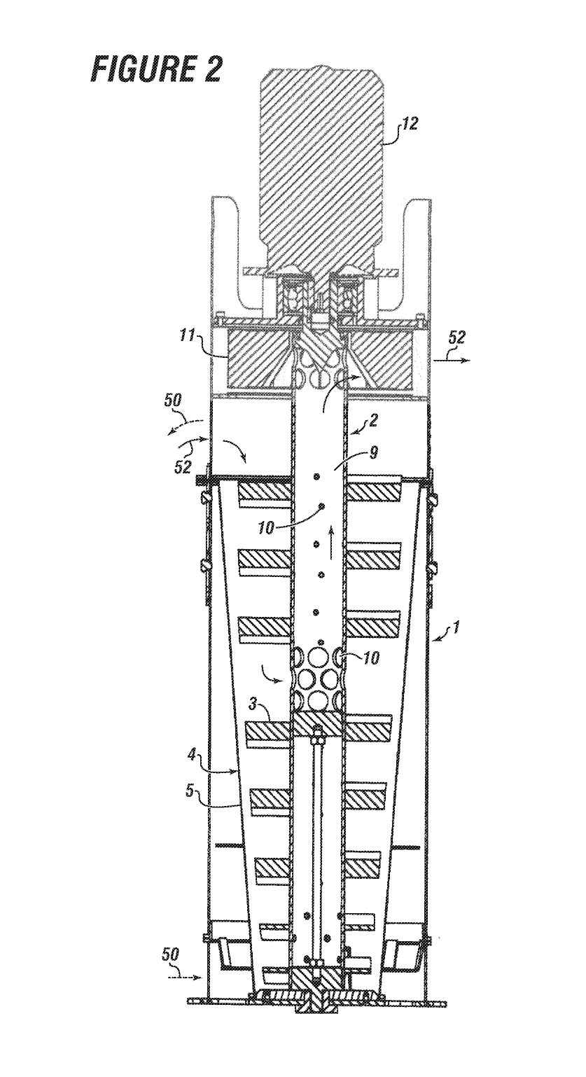

FIG. 2 is a cross sectional view of the device for drying granules of FIG. 1.

Inside housing 1 there can be a rotor 2 having at least one rotor blade disposed thereon. The rotor 2 and rotor blade 3 impart a direction of movement to granules and to a process fluid respectively. The movement separates the process fluid from the granules in the region of rotation of the rotor using a sieve 4 at least partially encompassing the outside of the rotor 2. The sieve 4 can have sieve openings 5 of a size smaller than the granules. Separation of granules and process fluid is accomplished by passing the process fluid from the sieve front side to the sieve back side.

The rotor 2 can have a hollow shaft 9 with a plurality of rotor holes 10 at least in one section of the hollow shaft 9. The rotor holes 10 in the middle portion of the hollow shaft 9 can be larger than the rotor holes 10 in the end portions of the hollow shaft 9.

The air route inside the device is shown by single arrows. The route taken by the granules inside the device is shown by the block arrows. As can be seen, a granule-process fluid mixture can be introduced in the bottom area of the housing 1 and, by rotation of the rotor 2 and by means of the rotor blade 3, the fluid mixture is moved upwards and the process fluid, is pressed radially outward through the sieve 4 with sieve openings 5. The process fluid is then evacuated from the housing via a process fluid outlet (not shown in the Figures). The process fluid outlet can be placed as desired by persons having ordinary skill in the art.

A fan wheel 11 can be attached coaxially to the hollow shaft 9. When the fan wheel 11 rotates, air can be drawn to the inside of the hollow shaft 9 via the granule outlet and the rotor holes 10. Air can be evacuated from the housing via a fan wheel air outlet 8, which can be seen in FIG. 1. This is shown by corresponding arrows in FIG. 2. In particular, it can also be seen that openings to the outer area of the fan wheel are provided in the top portion of the hollow shaft.

In embodiments, the fan wheel 11 and the rotor 2 can be driven at the same speed by a common motor 12. The common motor 12 can be seen in FIG. 1 and FIG. 2. To facilitate cleaning, the rotor 2 together with the fan wheel 11 can be removed out of the assembled position upwards out of the housing 1.

The rotor blade 3 can be disposed spirally on at least a portion of the hollow shaft 9. The rotor blade 3 can have an outer contour which matches the inner contour at a given cross section substantially orthogonal to the axis of the hollow shaft. The respective outer edges of the at least one rotor blade 3 can be kept a constant distance from the inner side of the sieve 4.

Generally speaking, envelope curves of the outer contour of the rotor blades and of the inner contour of the sieve can be coaxially disposed and the inner envelope curve of the respective rotor blades can have a radial distance from the outer envelope curve of the sieve. This distance can be approximately 5 times the average diameter of the granules to be separated from the process fluid. The rotor blades 3 and the sieve 4 can have a conically tapering path, at least in sections, in the assembled position, from top to bottom in the vertical cross-section.

The rotor holes 10 can be larger in the middle portion of the rotor 2. In embodiments, the rotor holes 10 can be about 0.3 times the inner diameter of the hollow shaft in the central area of the hollow shaft 9. In the end portions of the rotor, the rotor holes 10 can be a substantially smaller diameter, such as about 1.5 times the diameter of the granules.

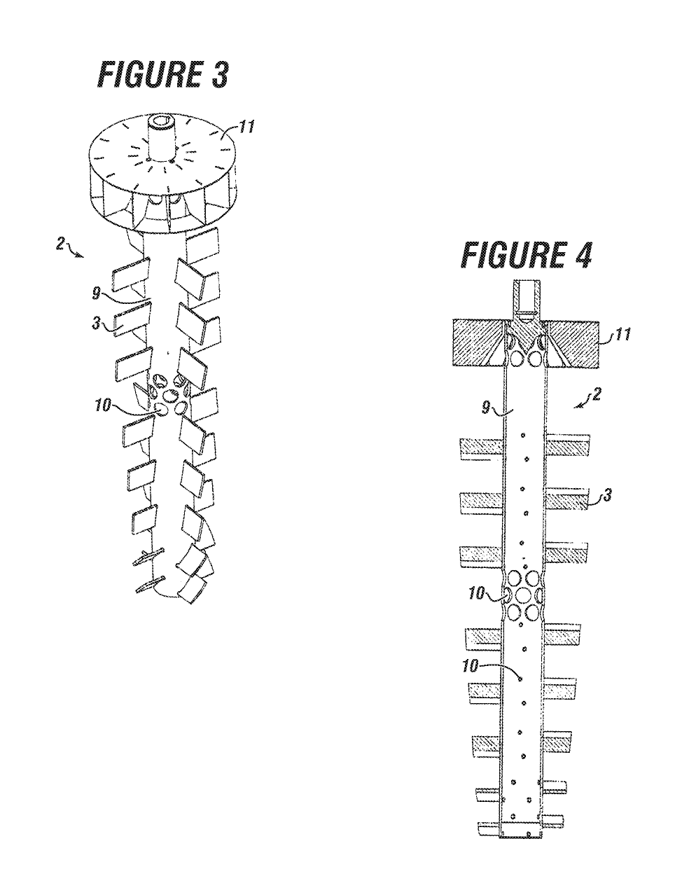

FIG. 3 is a view of one embodiment of the rotor and fan wheel arrangement of the device for drying granules of FIG. 1 and FIG. 2.

In embodiments, the fan wheel 11 and the rotor 2 can be attached to each other in a fixed manner. The hollow shaft 9 can have rotor holes 10, particularly in the middle portion. The rotor blade 3 can be disposed spirally on the hollow shaft 9, at least in sections. The pitch of the spiral can increase from the bottom to the top in FIG. 3 (or from one end of the hollow shaft 9 to the other), allowing a different upward flow component to be imparted to the granules in each portion.

In the bottom portion, the component of movement imparted by the correspondingly spirally disposed rotor blades can be greater than in the top portion, whereby, in the top portion, a substantial separation of granules and process fluid should already have been completed. There could also be functional advantages with regard to desired dwell times in certain areas or imparted directions of movement, if the pitch were varied by persons having ordinary skill in the art.

For example, contrary to the illustration in FIG. 3, if the pitch were to decrease, not increase, persons having ordinary skill in the art could vary dwell times or separation forces.

FIG. 4 is a cross-sectional view of the rotor and fan wheel arrangement of FIG. 3.

It can be seen here that the rotor holes 10 disposed in the top and bottom portions of the hollow shaft 9 have substantially smaller diameters than the rotor holes 10 in the middle portion of the hollow shaft 9.

With rotor blades disposed spirally, a particularly efficient separation of granules and process fluid can be achieved. By connecting the fan wheel 11 and the rotor 2 an air flow is created, which improves the process of separating granules and process fluid in a particular manner.

While the present disclosure emphasizes the presented embodiments and Figures, it should be understood that within the scope of the appended claims, the disclosure might be embodied other than as specifically enabled herein.

What is claimed is:

1. A device for drying granules, comprising:
a. a housing comprising:
(i) a granule-process fluid inlet;
(ii) a granule outlet;
(iii) a fluid outlet; and
(iv) a fan wheel air outlet;
b. a rotor comprising:
(i) a hollow shaft with a plurality of rotor holes;
(ii) at least one rotor blade; and
(iii) at least one sieve encompassing the outside of the rotor, having sieve openings of a size smaller than the granules; and
c. a fan wheel; and
wherein the at least one rotor blade imparts a direction of movement to granules and to a process fluid respectively, such that the process fluid can be separated from the granules, and further wherein the fan wheel draws air into the hollow shaft via the granule outlet and the plurality of rotor holes and the air is evacuated through the fan wheel air outlet.

2. The device of claim 1, wherein the at least one rotor blade is disposed spirally on the hollow shaft, and further wherein the at least one rotor blade has an outer contour which substantially matches the inner contour of the at least one sieve.

3. The device of claim 1, wherein the at least one rotor blade is disposed spirally on the hollow shaft, and further wherein the at least one rotor blade has a changing pitch.

4. The device of claim 1, wherein an outer contour of the at least one rotor blade and an inner contour of the at least one sieve are coaxially disposed, and the radial distance of the at least one rotor blade from the at least one sieve is from 4 times to 20 times the average diameter of the granules.

5. The device of claim 1, wherein the at least one rotor blade and the at least one sieve comprise a conically tapering path.

6. The device of claim 1, wherein the rotor and the fan wheel are rotated at the same speed.

7. The device of claim 1, wherein the rotor and the fan wheel are in driven by a common motor.

8. The device of claim 1, wherein the fan wheel is disposed above the rotor in the assembled position.

9. The device of claim 1, wherein the plurality of rotor holes are disposed in a middle portion of the rotor.

10. The device of claim 1, wherein at least one hole of the plurality of rotor holes has a diameter from 0.25 times to 0.40 times the inner diameter of the hollow shaft.

11. The device of claim 1, wherein at least one hole of the plurality of rotor holes has a diameter from 0.5 times to 2 times the diameter of the granules.

12. The device of claim 1, wherein the rotor and the fan wheel can be removed from the housing.
